(19) United States
(12) Patent Application Publication
(10) Pub. No.: US 2007/0140682 A1
(43) Pub. Date: Jun. 21, 2007

(54) Two camera stereoscopic 3D rig improvements

(76) Inventors: Bernard J. Butler-Smith, Malibu Lake, CA (US); Steven J. Schklair, Altadena, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/486,367

(22) Filed: Jul. 14, 2006

Related U.S. Application Data
(60) Provisional application No. 60/698,961, filed on Jul. 14, 2005.

(51) Int. Cl. G03B 35/00

(52) U.S. Cl. 396/325

(57) ABSTRACT

Ongoing research and development on Stereoscopic 3D Camera rigs has led to certain new and unique improvements, including a trapezoidal beam-splitter mirror, a beam-splitter mirror that is facing downwards, a stereoscopic platform that can be inverted 180°, an optical wedge for vertical field-of-view refraction compensation, a single inter-ocular motor with dual rack-and-pinion gear system, dual convergence motors on worm gears, a convergence rotation under first-nodal point, and an electronics control mounted under the mirror.

### CROSS-REFERENCE TO RELATED APPLICATIONS

This application claims priority to provisional application entitled, TWO CAMERA STEREOSCOPIC CAMERA PLATFORM, filed Jul. 14, 2005, having a Ser. No. 60/698,961, which is hereby incorporated by reference in its entirety.

### FIELD OF THE INVENTION

The present invention relates generally to stereoscopic 3D camera systems.

### BACKGROUND OF THE INVENTION

There are various types of stereoscopic 3D camera rigs, and the methods of configuring them vary for different designs, and 3D shooting philosophies.

There are beam-splitter types, which allows the inter-ocular distance to be varied from zero to its maximum travel range. For close-up stereography, this type provides the only possible way to shoot.

There are side-by-side camera types, which have their minimum inter-ocular distance limited by the size of the cameras or their lenses. This configuration does not allow close-up shooting because of this limitation.

This invention mainly pertains to the beam-splitter types, but has some application to side-by-side camera types.

This invention has various parts, each of which provide enhancements to a new and improved stereoscopic 3D camera rig.

### SUMMARY OF THE INVENTION

The enhancements to the stereoscopic 3D camera rig are summarized as follows:
a) Trapezoidal beam-splitter mirror, the ideal shape.
b) Beam-splitter mirror facing downwards to minimize dust collection, and light reflections.
c) Upside-down compatible 3D Camera Rig.
d) Optical Wedge for vertical field-of-view refraction compensation.
e) Single Inter-Ocular motor, with a dual rack-and-pinion gear system, for speed and inherent matching.
f) Dual convergence motors on worm gears.
g) Convergence rotation under first-nodal point.
h) Electronics control mounted under mirror.
i) Unique Ergonomic Design.

### BRIEF DESCRIPTION OF THE DRAWINGS

FIG. 1 shows the side view of a typical beam-splitter 3D camera rig, showing the fields of view of both cameras.

FIG. 2 shows the surface requirements of an ideal beam-splitter mirror, which is a trapezoidal shape.

FIG. 3 shows the ray-traced optical paths of the vertical field of view of both cameras of a typical beam-splitter stereoscopic 3D camera rig,

### DETAILED DESCRIPTION

a) Trapezoidal Beam-splitter Mirror.

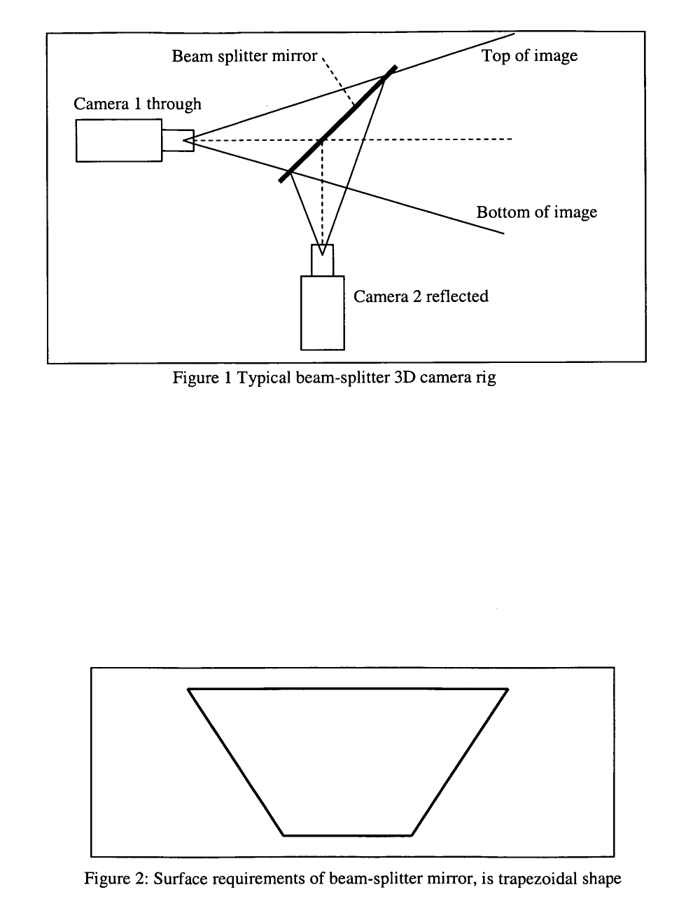

To reduce the weight and size of a beam-splitter type 3D camera rig, the beam-splitter mirror needs to be only large enough to accommodate the optical paths to the imager (CCD, CMOS of film). A typical 3d rig with a 50/50 beam-splitter mirror, at 45 degrees to the optical centers, is shown in FIG. 1.

It is not necessary for the beam-splitter mirror to be rectangular, as is the case with other 3D rigs. In fact, by ray-tracing the optical paths from each camera, they are bound by a pyramid shape, therefore a 45 degree intersection into this pyramid by the beam-splitter mirror creates a trapezoidal shape, as shown in FIG. 2.

b) Beam-splitter Mirror Facing Downwards

To reduce dust collection on the surface of the mirror, and to reduce the effect of ambient light reflecting into the view of Camera 2 of FIG. 1, Camera 2 is made to look upwards, with the reflecting surface of the beam-splitter mirror facing downwards.

c) Upside-down Compatible 3D Camera Rig

The whole 3D rig can be flipped upside-down in some cases. Camera 2 of FIG. 1 would then be on the top, and looking down. This is needed when shooting close to the ground. The beam-splitter mirror would be close to the ground in this case.

d) Optical Wedge for Vertical Field-of-view Refraction Compensation

The beam-splitter mirror consists of a “through-the-glass” surface, transmitting 50% of light passing through, and a “reflected surface” reflecting 50% of light impinging upon it.

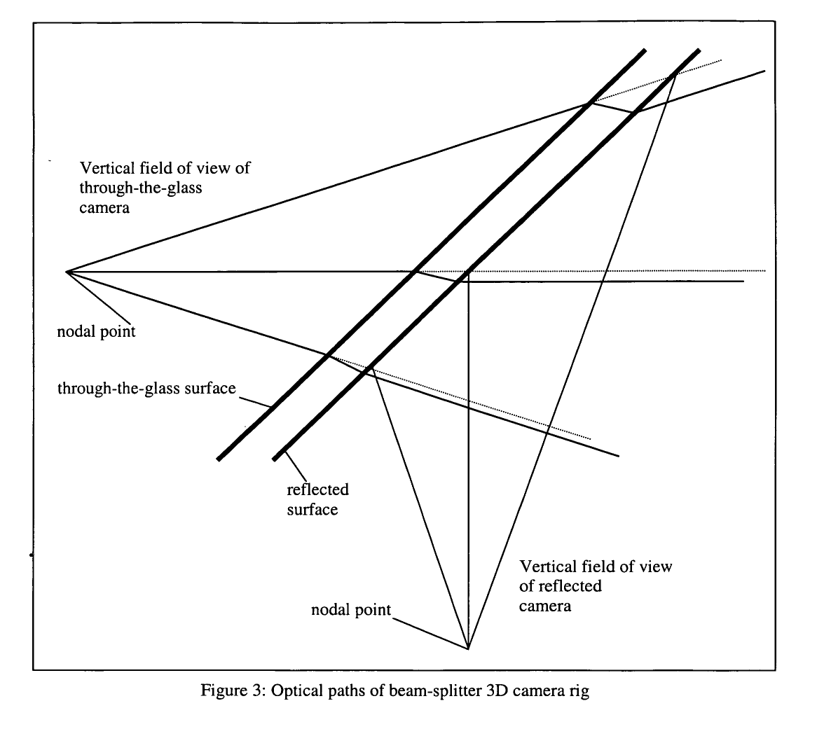

The optical path through the beam-splitter's “through-the-glass” surface can undergo a varying vertical shift across the surface of the glass due to varying refraction across the vertical field of view of the camera, and this distortion is magnified by the thickness of the glass used by the beam-splitter. FIG. 3 shows the optical path of the vertical field of view of both cameras. Notice the difference between the reflected camera's field of view (which has no refracted distortion).

To compensate for this distortion, an optical wedge is placed between the through-the-glass camera, and the beam-splitter mirror. This optical wedge, would “stretch” the light path towards the top, to compensate for the “compression” of the light path towards the top of the beam-splitter mirror.

e) Single Inter-Ocular Motor, with Dual Rack-and-pinion Gear System.

A single motor drives the inter-ocular movement of the 3D camera rig, on a rack-and-pinion gear. This ensures both cameras move together and apart at the same symmetrical velocity. The relative velocity is doubled by this opposing motion, thereby allowing faster inter-ocular movement.

f) Dual Convergence Motors on Worm Gears.

High-resolution motion control of two convergence motors is required for the best 3D stereography. A geared motor driving an additional worm gear provides the best gear ratio, while providing the best electro-optical encoded positional feedback resolution. Also, this symmetrical parallax movement of both cameras provides the use of a symmetrical trapezoidal beam-splitter mirror.

g) Convergence Rotation Under First-nodal Point.

It is required for minimum optical distortion during a convergence (parallax) movement that the center of rotation of this movement is directly aligned with the first-nodal point, or exit pupil nodal point of the lens. This can be accomplished mechanically by providing a pivot point for the convergence which coincides with the first-nodal point. This can also be accomplished electronically by motor control of the convergence an inter-ocular motors, such that the rotational point is a calculated vector offset for each of these motors.

h) Electronics Control Mounted Under Mirror.

The placement of the electronics, such as the motion control system, is important to the design of the 3D rig. It needs to be as close to the motors as possible for two reasons. Firstly to reduce the length of wiring on the rig, which reduces weight and wiring clutter, and secondly there are relatively high currents going to motors, which requires shorter cabling to reduce the inherent resistance of the wire and minimizes power dissipation to the cable. For this reason, an ideal mounting position of the electronics is required. Underneath the beam-splitter mirror, between the cameras, and under the widest vertical field of view of the cameras was found to be the optimal position for the electronics.

i) Unique Ergonomic Design.

By designing the 3D camera platform around a central curved “rib”, instead of two metal plates joined together in an “L” shaped assembly, the camera platform can be made more ergonomic and used for “hand-held” photographic work. This has the added advantage of bringing the center of gravity closer to the camera bodies.

What is claimed is:

1. A process of using a trapezoidally shaped beam-splitter mirror in a stereoscopic 3D camera rig.

2. A method of claim 1, where the beam-splitter mirror has its reflecting surface facing downwards.

3. A method of claim 1, where the 3D rig may be inverted.

4. A process of using an optical wedge, or prism, to compensate for vertical refractional deviations in the through-mirror camera view in a beam-splitter type stereoscopic 3D camera rig.

5. A process of using a single motor, with a dual rack-and-pinion gear system, for speed and inherent matching, to drive the inter-ocular placement of a stereoscopic 3D camera rig.

6. A process of using dual convergence motors on worm gears, to drive the convergence placement of a stereoscopic 3D camera rig.

7. A process of convergence rotation under the first-nodal point, by mechanical pivot point.

8. A process of convergence rotation under the first-nodal point, by motor control of the combination of convergence an inter-ocular motors.

9. A method of mounting the electronics control of a stereoscopic 3D camera rig under the beam-splitter mirror assembly.

10. A process of manufacturing a unique ergonomic and practical stereoscopic 3D camera rig design, using an “L” shaped assembly.
